(19) United States
(12) Patent Application Publication
(10) Pub. No.: US 2017/0008751 A1
(43) Pub. Date: Jan. 12, 2017

(54) WINE PRESERVING PACKAGING

(71) Applicant: Sarfaraz K. Niazi, Deerfield, IL (US)

(72) Inventor: Sarfaraz K. Niazi, Deerfield, IL (US)

(21) Appl. No.: 14/793,387

(22) Filed: Jul. 7, 2015

(51) Int. Cl. B67D 3/00; B65D 33/16

(52) U.S. Cl. CPC B67D 3/0067; B65D 33/1616

(57) ABSTRACT

A container and method for dispensing degradable beverages, such as wine, from a non-chemical leaching polymer container, while insuring that gaseous contaminants such as oxygen cannot enter the container.

### BACKGROUND OF THE INVENTION

In recent years, there has been a great increase in wine consumption. As more people have become familiar with better quality wines, they have also become sensitive to the degradation which occurs when an open bottle of wine is recorked and reused at a later time. The problem appears to be that when a wine bottle is opened for an initial pouring, oxygen in the air enters the bottle and is trapped there when the bottle is recorked. The trapped oxygen apparently chemically interacts with the wine remaining in the bottle, causing changes in the taste, aroma, and color of the wine. Thus, when the bottle is reopened at a later date, the quality of the wine is found to be significantly degraded.

In some commercial wine handling processes it is known to transfer wine from one container to another under the pressure of nitrogen gas admitted to the container. Reference to such a process is made in the textbook entitled, Technology of Wine Making, Second Edition, by Amerine, Berg, and Cruess. Additionally, there are commercial devices available for wine dispensing by bars which use high pressure nitrogen to drive the wine from a metal container to a dispensing tube at the bar. However, it does not appear that any satisfactory method or device is presently known which will allow safe dispensing of wine from a wine bottle, while preventing oxygen in the air from degrading the beverage both during dispensing and bottled storage between dispensing events.

In U.S. Pat. No. 3,750,915, issued to P. Kearny on Aug. 3, 1973, the problem of wine spoilage by air is addressed. Kearny disclosed a spout including a plug which prevents air from entering the bottle during storage periods. However, the spout is adapted to admit air during the pouring of the wine. This air will be trapped in the bottle during storage when it can chemically interact with the stored wine.

Recently, another device has been marketed in which wine is packaged not in a glass bottle, but in a plastic container having a dispensing spigot near the bottom. As the wine is dispensed from the spigot, atmospheric pressure collapses the plastic container in the region left empty by the poured wine. Since no air is admitted to the container at any time, no deterioration of the wine takes place during pouring or later storage. Although air is excluded by this method, it has been, and continues to be, the case that higher quality wines are bottled and corked in glass bottles, and are not made available in plastic dispensing containers. The reason for this lies in the inevitable leaching of chemicals from plastic container, which is expedited by the presence of alcohol, lack of breathing of wine as it takes place through a traditional cord and the non-esthetic appearance of this type of container.

In U.S. Pat. No. 4,595,121, issued to Sheldon with priority date of 10 Sep. 1984, allows dispensing of wine by pressurizing the bottle using an inert gas. This patent has expired. Recently, a similar device has been marketed in which wine is poured through a sharp needle inserted in the wine bottle, pressurizing the bottle with an inert gas and allowing the wine to drain out by turning the bottle upside down. While this device prevents entering of oxygen in the wine bottle and provides the required protection, the process of operating a compressed gas cylinder, which requires an elaborate and expensive mechanical arrangement, adds to the complexity and cost of preserving wine. There is other prior art that involves similar principle of pressurizing the wine bottle.

The U.S. Pat. No. 4,684,033 describes a method wherein a container is used to remove excess air in the wine bottle to prevent degradation.

### SUMMARY OF THE INVENTION

In accordance with the illustrated preferred embodiments, the present invention provides a container and method for dispensing degradable beverages, such as wine, from a flexible, collapsible, non-leaching fluoropolymer container, while insuring that gaseous contaminants such as oxygen cannot enter the container substantially. During storage between dispensing events, oxygen is still excluded from the container, once the dispensing port is closed.

In accordance with aspects of the invention, the container is configured (and the method steps are arranged) to insure that there is no inadvertent admission of oxygen during dispensing by allowing the wine to flow out from an upside down container, wherein gravity flow provides the dispensing; once the dispensing port is closed, the bottle becomes sealed again.

### DESCRIPTION OF THE DRAWINGS

FIG. 1 shows a container containing a degradable beverage, the container having a dispensing tube and a clamp attached.

### DETAILED DESCRIPTION OF THE PREFERRED EMBODIMENT

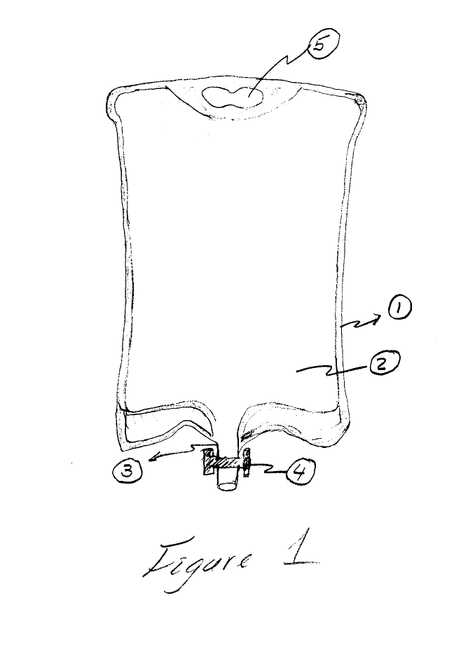

In FIG. 1, depicts a flexible and collapsible bag 1, completely filled with a degradable beverage 2. For purposes of this disclosure, a “degradable beverage” is taken to be a liquid intended for human consumption whose taste, color, appearance, or texture would be altered by contact with liquid or gaseous substances, including air or oxygen; in particular, a degradable beverage is meant to include wine. A tube 3 is fitted into the bag container 1, to which a clamp 4 is applied that will hermetically seal the tube 3 when closed. A means of hanging the container 5 that allows upside down orientation of the bag by attaching it to any support element, such as a hook.

Beverage products come in a variety of packaging styles. For example, carbonated beverages are supplied in traditional glass bottles, in plastic bottles and in aluminum cans. Wine, by contrast has been traditionally sold in glass bottles, although the use of a cardboard cask container enclosing a container is also known and there have been more recent attempts, as yet not commercially widespread, to promote wine in alternative packages such as aluminum cans or even cartons of the type typically used for milk and fruit juice products.

There are underlying reasons driving demand for alternative packaging methods to those traditionally used including the cost of manufacture, the volume able to be stored for domestic applications, the issue of oxidation and/or microbial contamination. We deal with each in turn.

First, it has been recognized that the traditional packaging methods are energy and resource intensive. The extraction and refining of aluminum and subsequent production of aluminum cans is extremely energy intensive. Manufactured aluminum products are therefore regarded as having a very high embodied energy. The environmental consequences of using aluminum in the manufacture of a single use throwaway item are now being subject to significant scrutiny and there is a general desire to move away from such products towards those products that are more sustainable.

Similarly, wine has traditionally been sold in glass bottles. As with aluminum, glass production is also an energy intensive process and the demand exists for more environmentally responsible methods of packaging.

Secondly, long term storage of liquids or beverages is readily achievable in packaging. The success of such packaging has been attributed to the fact that it is cheap to produce and maintains the packaged liquid sterile and free from oxygen ingress and microbial spoilage. However, once opened for consumption, this packaging type offers no protection against oxidation or microbial contamination and the liquid deteriorates rapidly. This is why such packaging is only suitable only for smaller volumes that will be consumed immediately or shortly thereafter upon opening the package.

A further driver for the development of alternative packaging methods is the demand for a packaging method that will allow the user to consume only a portion of the contents of the package without compromising the quality, or reducing the longevity of the remaining package contents.

Wine is produced from the fermentation of plant sugars into alcohol by yeasts. Typically the alcohol content of a wine is in the region of 9-15% alcohol by volume. In addition to the alcohol content wines typically contains a myriad of complex organic compounds that contribute to the taste and flavor of the product. Most but not all of these organic compounds, including the alcohol, may be subject to chemical reaction on exposure to atmospheric oxygen producing a chemically altered product. The chemistry of wine is complex and there is merit, in some cases, of exposing a wine to atmospheric oxygen—generally known as allowing a wine to ‘breathe’. However, extended exposure to oxygen can result in the wine being ‘oxidized’, and, as a result, becoming unpalatable. Although various reactions may be involved, oxidation does at least affect the alcohol present in the wine in that prolonged exposure to oxygen will result in alcohol being oxidized to aldehydes and ultimately to acetic acid. Thus, wine from a standard 750 ml narrow necked bottle will deteriorate slowly, but appreciably, after opening such that, in most cases, a noticeable drop in quality of a red wine may be perceived after only a few days at the very most.

As an alternative to the use of a wine bottle, the wine cask has been developed and used successfully, also known as the container in box (BIB). A wine cask consists of a flexible metallized polymer container holding wine attached to a dispensing tap. In use, a wine cask has a limited life span of around 9 months, as the polymer container is to some degree permeable to oxygen. The BIB is the most common and popular bulk liquid storage packaging that offers intermittent liquid dispensing. The principle of operation of the BIB involves the liquid being contained within a collapsible container that requires gravity to push the contents out of a dispensing tap.

There are several limitations to the BIB. These are:

(a) Liquids sensitive to oxidation have a limited shelf life in the BIB due to oxygen ingress through the collapsible container during storage. Forty percent of the oxygen ingress in the BIB occurs as a result of direct oxygen permeability into the stored liquid through the container itself.

(b) Oxidation further increases by another 60% when the consumer begins dispensing liquid as a result of oxygen ingress through the dispensing tap.

(c) Microbial contamination can enter through the dispensing tap during use.

(d) Leaching of chemicals from the containers is a serious issue that has not been dealt with earlier. The ability of packaging systems to contribute leached substances to liquids is well established. This is further exacerbated when the liquid contains alcohol. The leachable include plasticizers, antioxidants, lubricants, stabilizers, binding agents, ink components, and many other chemicals that are found in the plastic containers currently used in BIB packaging. Given the complexity of the reactions that take place when the wine ages, presence of any of these chemicals can significantly alter the structure of wine, leading to rapid degradation and loss of flavor and taste. The same applies to any other plastic components used in BIB, including the dispensing ports. Since red wine continues to age in the final container and is allowed to stay in there often for years, the cumulative effect of storing wines in a plastic container that would leach will be disastrous. It is for this reason that only cheaper wines are provided in BIB packaging.

Of all polymers available, the fluoropolymers are unique in that they do not need any additive to form a surface and are thus of non-leaching type; they also have very high resistance to permeability of gases, have high strength and durability. They are also resistant to acidic pH (which is the case with red wines), and can last for a very long time without deterioration. To date, there is no prior art on using a fluoropolymer flexible container to store wines or other degradable beverages.

Beverages contained in fluoropolymer containers offer a new opportunity for cost-effective methods of preventing degradation while the beverages are in use.

In one embodiment, the present invention offers an extremely cost-effective solution to storage and serving of alcoholic beverages that are subject to degradation if exposed to oxygen.

In another embodiment, the present invention offers portioning the contents of a wine without having the need to consume the whole bottle.

In another embodiment, the present invention offers a possibility to order smaller portions of high-end wines.

In another embodiment, the present invention offers a long-term storage of degradable beverages without affecting their quality.

The foregoing descriptions of specific embodiments of the present invention are presented for the purposes of illustration and description. They are not intended to be exhaustive or to limit the invention to the precise forms disclosed; obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

1. A container for storing and preventing spoilage of a degradable beverage while dispensing the beverage from said container and during storage of the beverage in said container between dispensing events, comprising:
a flexible and collapsible bag made of a fluoropolymer, having an inner volume;
a dispensing means further comprising a flexible tube made of a fluoropolymer attached to said flexible and collapsible bag and a clamp attached to said flexible tube to seal it hermetically when closed.

2. (canceled)

3. The container of claim 1, wherein the fluoropolymer is, perfluoroalkoxy (PFA), or fluorinated ethylene propylene (FEP).

4. A method of preventing spoilage of a degradable beverage while dispensing of the beverage from a container and during storage of the beverage in the container between dispensing events comprising:
a) providing the container of claim 1;
b) completely filling the flexible and collapsible bag of said container with a degradable beverage;
d) hanging the container upside down;
e) opening the clamp;
f) collecting the beverage; and,
g) closing the clamp.
